(19) United States
(12) Patent Application Publication
(10) Pub. No.: US 2026/0324544 A1
(43) Pub. Date: Oct. 22, 2026

(54) Velocity Based Reel Commands

(71) Applicant: Autonomous Solutions, Inc., Mendon, UT (US)

(72) Inventors: James Yonk, Mendon, UT (US); Bret Turpin, Mendon, UT (US); Mike Hornberger, Mendon, UT (US); Mckord Harris, Mendon, UT (US); Nate Bunderson, Mendon, UT (US)

(21) Appl. No.: 19/462,870

(22) Filed: Jan. 28, 2026

Related U.S. Application Data
(60) Provisional application No. 63/751,987, filed on Jan. 31, 2025.

(51) Int. Cl. A01D 34/00; A01B 69/04; A01B 79/00; A01D 101/00; G05D 1/225; G05D 107/20

(52) U.S. Cl. CPC A01D 34/008; A01B 69/008; A01B 79/005; G05D 1/225; A01D 2101/00; G05D 2107/21; G05D 2107/23

(57) ABSTRACT

A system and a method are disclosed for controlling operation of an implement coupled to the autonomous work vehicle. The system includes an implement control system, a sensor array configured to generate sensor data representative of at least one operating parameter of the autonomous work vehicle, and a vehicle control unit communicatively coupled to the implement control system and the sensor array. A processing unit receives the sensor data and generates a control signal corresponding to a desired point along a path. An offset distance for execution of the control signal is calculated based on at least one of a current velocity, a maximum anticipated velocity, and a time required to actuate the implement into a desired state. The control signal is executed such that movement of the implement is initiated prior to reaching the desired point and the implement reaches the desired state at the desired point.

### BACKGROUND

With ongoing technological advancements, the use of autonomous work vehicles across various applications has increased significantly. Such autonomous work vehicles perform tasks with reduced human involvement or, in some instances, without human intervention.

Typically, the autonomous work vehicles, such as mowing vehicles, agricultural vehicles, or other ground-engaging vehicles, employ implements whose operation is controlled relative to motion or progress of the autonomous work vehicles. In such conventional autonomous work vehicles, implement control is based on a distance-related parameter, which can be inefficient or inaccurate under varying operating conditions.

Therefore, in the light of the foregoing discussion, there exists a need to overcome the aforementioned drawbacks associated with the conventional autonomous work vehicles related to engagement of the implement working in varying operating conditions.

### SUMMARY

An autonomous work vehicle with an implement is disclosed. The autonomous work vehicle may comprise an implement control system configured to control operation of an implement coupled to the autonomous work vehicle. The autonomous work vehicle may comprise a sensor array configured to generate sensor data representative of at least one operating parameter of the autonomous work vehicle. The autonomous work vehicle may comprise a vehicle control unit communicatively coupled to the implement control system and the sensor array. The system may comprise a processing unit communicatively coupled to the vehicle control unit. The processing unit may comprise a processor and a memory storing processor-executable instructions that, when executed by the processor, cause the processing unit to receive the sensor data corresponding to at least one operating parameter of the autonomous work vehicle from the sensor array. The processing unit may generate a control signal for the implement control system to control operation of the implement corresponding to a desired point along a path of the autonomous work vehicle. The processing unit may calculate an offset distance for execution of the control signal based on at least one of a current velocity, a maximum anticipated velocity of the autonomous work vehicle, and a time required to actuate the implement into a desired state. The processing unit may associate the offset distance with the control signal as a distance from the desired point along the path at which the control signal is to be executed. The processing unit may transmit the control signal comprising the associated offset distance to the vehicle control unit. The vehicle control unit may execute the control signal using the offset distance such that movement of the implement is initiated prior to the autonomous work vehicle reaching the desired point and the implement reaches the desired state at the desired point along the path.

An autonomous work vehicle with an implement is disclosed. The autonomous work vehicle may comprise an implement control system configured to control operation of an implement coupled to the autonomous work vehicle. The autonomous work vehicle may comprise a sensor array configured to generate sensor data representative of at least one operating parameter of the autonomous work vehicle. The autonomous work vehicle may comprise a vehicle control unit communicatively coupled to the implement control system and the sensor array. The autonomous work vehicle may comprise a processing unit communicatively coupled to the vehicle control unit. The processing unit may comprise a processor and a memory storing processor-executable instructions that, when executed by the processor, cause the processing unit to receive the sensor data corresponding to at least one operating parameter of the autonomous work vehicle from the sensor array. The processing unit may generate a control signal for the implement control system to control operation of the implement corresponding to a desired point along a path of the autonomous work vehicle. The processing unit may calculate an offset distance for execution of the control signal based on at least one of a current velocity, a maximum anticipated velocity of the autonomous work vehicle, and a time required to actuate the implement into a desired state. The processing unit may associate the offset distance with the control signal as a distance from the desired point along the path at which the control signal is to be executed. The processing unit may transmit the control signal comprising the associated offset distance to the vehicle control unit. The vehicle control unit may execute the control signal using the offset distance such that movement of the implement is initiated prior to the autonomous work vehicle reaching the desired point and the implement reaches the desired state at the desired point along the path.

A method for controlling an implement of an autonomous work vehicle may be provided. The method may comprise receiving, by a processing unit, sensor data corresponding to at least one operating parameter of the autonomous work vehicle from a sensor array. The method may comprise generating, by the processing unit, a control signal for an implement control system to control operation of the implement corresponding to a desired point along a path of the autonomous work vehicle. The method may comprise calculating, by the processing unit, an offset distance for execution of the control signal based on at least one of a current velocity, a maximum anticipated velocity of the autonomous work vehicle, and a time required to actuate the implement into a desired state. The method may comprise associating, by the processing unit, the offset distance with the control signal as a distance from the desired point along the path at which the control signal is to be executed. The method may comprise transmitting, by the processing unit, the control signal comprising the associated offset distance to a vehicle control unit. The method may comprise executing, by the vehicle control unit, the control signal using the offset distance such that movement of the implement is initiated prior to the autonomous work vehicle reaching the desired point and the implement reaches the desired state at the desired point along the path.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, examples are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following:

FIG. 1 is a block diagram illustrating a communication architecture for a system, in accordance with an embodiment of the present disclosure.

FIG. 2A and FIG. 2B collectively illustrate depiction of actuation of an implement coupled to an autonomous work vehicle, in accordance with an embodiment of the present disclosure.

FIG. 3 is a schematic illustration of an example autonomous work vehicle.

FIG. 4 is a schematic illustration of another example autonomous work vehicle.

FIG. 5 is a schematic illustration of another example autonomous work vehicle.

FIG. 6 is a flowchart depicting various steps of a method for controlling operation of the implement coupled to the autonomous work vehicle.

FIG. 7 is a block diagram of an example computational system (or controller).

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates examples of an autonomous work vehicle. Although some modes of carrying out the present disclosure have been disclosed, those skilled in the art would recognize that other embodiments for carrying out or practicing the present disclosure are also possible.

An autonomous work vehicle with an implement or coupled with an implement is disclosed. The autonomous work vehicle may be engaged or disengaged at an offset time in order to ensure the implement is engaged or disengaged at the proper place or time.

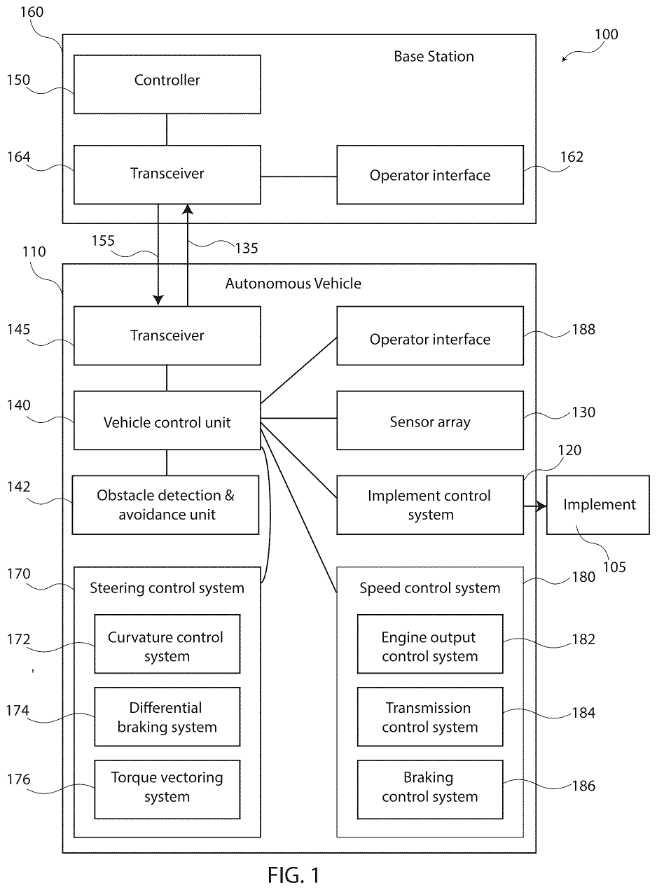

FIG. 1 is a block diagram illustrating a communication architecture for a system, in accordance with an embodiment of the present disclosure. With reference to FIG. 1, there is shown communication architecture for a system 100 including an autonomous work vehicle 110, a base station 160, and a user device.

The autonomous work vehicle 110 includes an implement control system 120 configured to control operation of an implement 105 coupled to the autonomous work vehicle 110.

Throughout the present disclosure, the term “autonomous work vehicle” refers generally to a vehicle configured to operate with reduced or no direct human intervention while performing one or more operations using the implement 105. For example, and without limitation, the autonomous work vehicle 110 may include a mower, yard truck, loader, wheel loader, track loader, dump truck, digger, backhoe, forklift, or other self-propelled vehicle capable of autonomously performing ground-engaging, material-handling, or work operations. The autonomous work vehicle 110 may operate individually or as part of a fleet, and the number, configuration, and type of autonomous work vehicle 110 may vary depending on the intended application and operating environment.

Throughout the present disclosure, the term “implement” refers generally to a tool, an attachment, or a work component operable by the autonomous work vehicle 110 whether coupled with the autonomous work vehicle or attached to the autonomous work vehicle or is part of the autonomous work vehicle. The implement 105 is coupled to the autonomous work vehicle 110 either directly or indirectly through one or more mounting structures or interfaces (not shown) and is configured to transition between different operational states during use. For example, and without limitation, the implement 105 may include a reel, a shovel, a mower attachment, a loader bucket, a fork assembly, a digging tool, or other ground-engaging or material-handling device. The specific structure, function, and mode of operation of the implement 105 may vary depending on the type of autonomous work vehicle 110, the operating environment, and the intended application.

Throughout the present disclosure, the term “implement control system” refers generally to a control subsystem including one or more hardware components, software components, or a combination thereof configured to control operation of the implement 105 coupled to the autonomous work vehicle 110. The implement control system 120 governs operational characteristics of the implement 105, including transitions between operational states and adjustment of parameters of the implement 105 required to control the implement 105. The implement control system 120 enables accurate and repeatable execution of operations of the implement 105 synchronized with vehicle motion of the autonomous work vehicle 110.

The implement control system 120 may include at least one actuator 522, actuator controllers, valves, motors, drives, or electronic control modules configured to control movement, engagement, disengagement, positioning, deployment, or retraction of the implement 105. The implement control system 120 may control the implement 105 via a communication interface, such as a CAN bus, ISOBUS, Ethernet, wireless communications, and/or Broad R Reach type Automotive Ethernet, etc. However, the specific architecture and configuration of the implement control system 120 may vary depending on the type of implement 105, the autonomous work vehicle 110, and the intended application.

In some embodiments, the implement control system 120, for example, may instruct an implement controller (not shown) to adjust operating characteristics of the implement, such as penetration depth of one or more ground-engaging tools, thereby reducing draft load on the autonomous work vehicle 110. The implement control system 120, as another example, may control transitions of an agricultural implement between a working position and a transport portion, to adjust a flow rate of product from the agricultural implement, to adjust a position of a header of the agricultural implement (e.g., a harvester, etc.), among other operations, etc. The implement control system 120, as another example, may control the implement 105 to adjust a shovel height, a shovel angle, a shovel position, etc.

The autonomous work vehicle 110 further includes a sensor array 130 configured to generate sensor data 135 representative of at least one operating parameter of the autonomous work vehicle 110. Throughout the present disclosure, the term “sensor array” refers generally to a plurality of sensors configured to generate the sensor data 135 representative of at least one operating parameter of the autonomous work vehicle 110 during operation, and in some implementations, conditions associated with a work area in which the autonomous work vehicle 110 operates.

The sensor array 130 may be present within the autonomous work vehicle 110 and configured to monitor vehicle motion, position, orientation, vehicle state, environmental conditions, or a combination thereof. Further, the sensor array 130 may generate the sensor data 135 indicative of vehicle velocity, steering angle, acceleration, position, or other dynamic characteristics relevant to vehicle operation of the autonomous work vehicle 110 and control of the implement 105. The specific composition, number, and placement of the plurality of sensors may vary depending on the type of the autonomous work vehicle 110, the implement 105 being controlled, and the intended operating environment.

In some embodiments, the sensor array 130 may include at least one of a velocity sensor, a steering angle sensor, an inertial measurement unit, a wheel encoder, a radar sensor, a lidar sensor, or a camera. In this regard, the velocity sensor is configured to produce data indicative of vehicle speed or motion of the autonomous work vehicle 110. The inertial measurement unit, a wheel encoder, a tachometer, a radar sensor, a lidar sensor, or a camera configured to derive motion-related information of the autonomous work vehicle 110. Further, the steering angle sensor is configured to generate the sensor data 135 representative of a steering position or steering rate of the autonomous work vehicle 110.

In addition, the radar sensor, the lidar sensor, or the camera may be configured to detect objects, terrain features, or environmental conditions in a vicinity of the autonomous work vehicle 110. Specifically, such sensors generate data representative of obstacles, work surface features, or spatial relationships relevant to operation of the autonomous work vehicle 110 and the implement 105.

Throughout the disclosure, the term “at least one operating parameter” refers generally to an operating parameter from a comprehensive set of measurable, computed, or derived vehicle motion, orientation associated with the autonomous work vehicle 110. The at least one operating parameter include, but not limited to, kinematic parameters such as vehicle position, speed, acceleration, and heading; dynamic parameters such as roll, pitch, rotational rates, and curvature rate; control-related parameters such as steering angle, steering limits, steering rate limits, and turning radius limits; and path-tracking parameters such as desired path location, off-path normal error, desired off-path normal error, and heading error. Vehicle state vector information and curvature state vector information collectively represent multi-dimensional representations of motion state of the autonomous work vehicle 110 used for prediction, planning, and control of the autonomous work vehicle 110. The at least one operating parameter contributes to describing the instantaneous and anticipated motion behavior of the autonomous work vehicle 110.

Further, the at least one operating parameter helps the system 100 to improve implement timing accuracy and repeatability across different speeds of the autonomous work vehicle 110, turning conditions, and terrain profiles. The inclusion of the at least one operating parameter enables predictive control rather than reactive control, resulting in improved work quality, reduced mechanical stress on the implement 105, and increased robustness of autonomous operation across a wide range of operating conditions.

The autonomous work vehicle 110 further includes a vehicle control unit 140 communicatively coupled to the implement control system 120 and the sensor array 130. Throughout the present disclosure, the term “vehicle control unit” refers generally to one or more electronic controllers with electrical circuitry configured to coordinate operation of systems associated with the autonomous work vehicle 110, including communication with the sensor array 130 and the implement control system 120. The vehicle control unit 140 includes obstacle detection and avoidance unit 142. The vehicle control unit 140 may further include one or more controllers, electronic control units, communication interfaces, or embedded computing devices, and may operate as a centralized controller or as part of a distributed control architecture of the autonomous work vehicle 110.

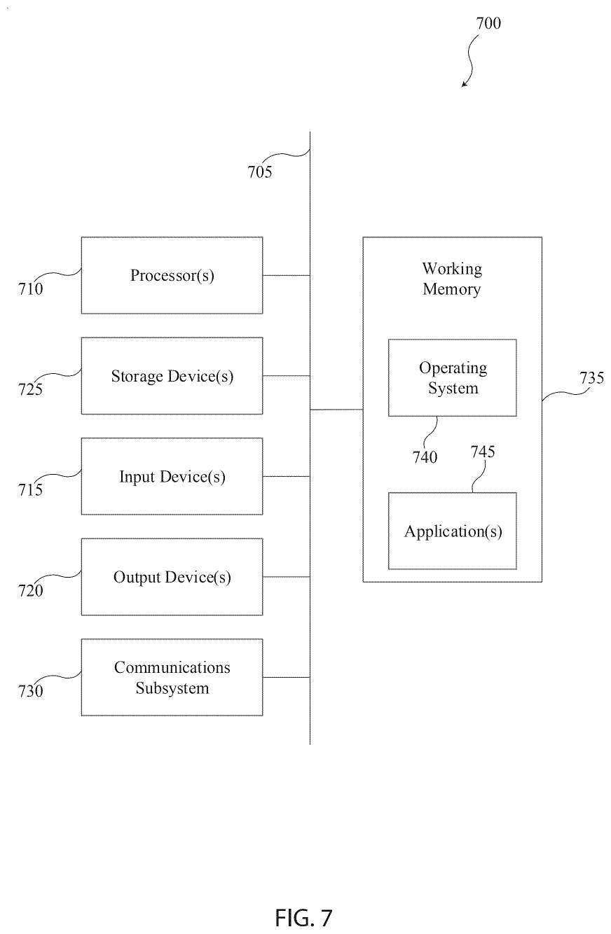

In some embodiments, the vehicle control unit 140 may include a processor operatively coupled to a memory and one or more storage components, thereby forming a computational system configured to execute software instructions. The processor may include one or more general-purpose or special-purpose processors, microcontrollers, or application-specific integrated circuits (ASICs), in any suitable combination. In some embodiments, the processor executes instructions for functions such as calculating drivable path plans and controlling operation of the autonomous work vehicle 110. For example, the processor may include one or more reduced instruction set (RISC) processors. The vehicle control unit 140, for example, may include any or all the components shown in FIG. 7.

The vehicle control unit 140, for example, may include a volatile memory, such as random access memory (RAM), and/or a nonvolatile memory, such as ROM (e.g., working memory and/or storage device). The memory may store a variety of information and may be used for various purposes. For example, the memory may store processor-executable instructions (e.g., firmware or software) for the vehicle control unit 140 to execute, such as instructions for calculating drivable path plan, and/or controlling the autonomous work vehicle 110. The memory may include flash memory, one or more hard drives, or any other suitable optical, magnetic, or solid-state storage medium, or a combination thereof. The memory may store data such as field maps, maps of desired paths, vehicle characteristics, software or firmware instructions and/or any other suitable data.

Further, the system 100 includes a processing unit 150 communicatively coupled to the vehicle control unit 140. The processing unit 150 includes a processor and a memory storing processor-executable instructions. Throughout the present disclosure, the term “processing unit” refers generally to one or more computing devices configured to perform control logic associated with an operation of the implement 105. The processing unit 150 may communicate with the vehicle control unit 140 via wired or wireless communication interfaces and may operate continuously or intermittently depending on configuration and operational requirements of the system 100.

The autonomous work vehicle 110 further includes a steering control system 170 configured to control a direction of movement of the autonomous work vehicle 110. The autonomous work vehicle 110 further includes a speed control system 180 configured to control at least one of speed, acceleration, and deceleration of the autonomous work vehicle 110.

In this regard, the term “steering control system” refers generally to a one or more steering subsystem, that enables directional control of the autonomous work vehicle 110. The steering control system 170, for example, may include a curvature rate control system 172, a differential braking system 174, and a torque vectoring system 176, that may be used to steer the autonomous work vehicle 110. The curvature rate control system 172, for example, may control a direction of the autonomous work vehicle 110 by controlling the steering control system 170 with a curvature rate, such as an Ackerman style autonomous work vehicle 110. The curvature rate control system 172, for example, may automatically rotate one or more wheels or tracks of the autonomous work vehicle 110 via hydraulic or electric actuators to steer the autonomous work vehicle 110. For example, the curvature rate control system 172 may rotate front wheels/tracks, rear wheels/tracks, and/or intermediate wheels/tracks of the autonomous work vehicle 110 or articulate the frame of the autonomous work vehicle 110, either individually or in groups. The differential braking system 174 may independently vary the braking force on each lateral side of the autonomous work vehicle 110 to direct the autonomous work vehicle 110. Similarly, the torque vectoring system may differentially apply torque from the engine of the autonomous work vehicle 110 to the wheels and/or tracks on each lateral side of the autonomous work vehicle 110. Further examples may include the steering control system 170 having other and/or additional systems to facilitate turning the autonomous work vehicle 110 such as an articulated steering control system, a differential drive system, and the like.

In this regard, the term “speed control system” refers generally to one or more subsystems providing longitudinal motion control and regulates vehicle velocity in accordance with operating conditions and planned vehicle motion of the autonomous work vehicle 110. The speed control system 180, for example, may control the speed of the autonomous work vehicle 110 based on map data, control algorithms, obstacle detection, start and/or stop points, or the like.

The speed control system 180, for example, may include an engine output control system 182, a transmission control system 184, and a braking control system 186. The engine output control system 182 may vary the output of the engine to control the speed of the autonomous work vehicle 110. For example, the engine output control system 182 may vary a throttle setting of the engine, a fuel/air mixture of the engine, a timing of the engine, and/or other suitable engine parameters to control engine output. In addition, the transmission control system 184 may adjust gear selection within a transmission to control the speed of the autonomous work vehicle 110. Furthermore, the braking control system 186 may adjust braking force to control the speed of the autonomous work vehicle 110. The speed control system 180, for example, may also include other systems and/or additional systems that may be used to control the speed of the autonomous work vehicle 110.

The speed control system 180 operates in coordination with the vehicle control unit 140 to regulate vehicle speed, acceleration, and deceleration based on the sensor data 135 and operational constraints. The inclusion of the steering control system 170 and the speed control system 180 improves the accuracy of actuation of the implement 105 by stabilizing vehicle motion while moving the autonomous work vehicle 110. Consistent directional control and velocity regulation reduce variability in vehicle behavior that could otherwise affect the timing of movement of the implement 105.

The autonomous work vehicle 110 further includes an operator interface 188 communicatively coupled to the vehicle control unit 140 and configured to display data from the autonomous work vehicle 110 via a display. Display data may include data associated with operation of the autonomous work vehicle 110, data associated with operation of the implement 105, a position of the autonomous work vehicle 110, a speed of the autonomous work vehicle 110, a desired path, a drivable path plan, a target position, a current position, etc. The operator interface 188 may enable an operator to control certain functions of the autonomous work vehicle 110 such as starting and stopping the autonomous work vehicle 110, inputting a desired path, etc. The operator interface 188, for example, may enable the operator to input parameters that cause the vehicle control unit 140 to adjust the drivable path plan. For example, the operator may provide an input requesting that the desired path be acquired as quickly as possible, that an off-path normal error be minimized, that a speed of the autonomous work vehicle 110 remains within certain limits, that a lateral acceleration experienced by the autonomous work vehicle 110 remains within certain limits, etc. In addition, the operator interface 188 (e.g., via the display, or via an audio system) may alert an operator if the desired path cannot be achieved, for example.

In some embodiments, the autonomous work vehicle 110 further includes a first transceiver 145 configured to send information from the autonomous work vehicle 110 and receive information from the base station 160.

In some embodiments, the processing unit 150 is located within a base station 160, the base station 160 being remote to the autonomous work vehicle 110 and communicatively coupled to the vehicle control unit 140. In this regard, the term “base station” refers generally to a unit that is physically separate from the autonomous work vehicle 110 and is configured to communicate with the vehicle control unit 140 over a communication network. The base station 160 may be fixed or mobile and may support communication with one or more autonomous work vehicles 110 operating within a defined area. Providing the processing unit 150 within the base station 160 enables centralized computation, coordinated control of a plurality of the autonomous work vehicles 110, and execution of computationally intensive control algorithms without increasing onboard vehicle computing requirements.

In some embodiments, the base station 160 may include an operator interface 162 communicatively coupled with the processing unit 150. The operator interface 162 can receive any of user inputs. The operator interface 162 allows the user to communicate commands to the autonomous work vehicle 110 and/or receive information about the autonomous work vehicle 110. In some embodiments, the base station 160 may further include a second transceiver 164 in communication with the first transceiver 145 (shown with arrows). The second transceiver 164 configured to send information from the base station 160 and receive information from the first transceiver 145.

In some embodiments, a user device may be in communication with at least one of the base station 160 and/or the autonomous work vehicle 110. The user device may include a smartphone, tablet, laptop, or computer. The user device, for example, may include an operator interface that can receive any of user inputs. The user device, for example, can include an application that allows the user to communicate commands to the autonomous work vehicle 110 and/or receive information about the autonomous work vehicle 110. Alternatively, or additionally, the user device, for example, can include an application that allows the user to observe the autonomous work vehicle 110 move through a map of the work area where the autonomous work vehicle 110 operates. In some embodiments, the user device may further include a third transceiver in communication with the first transceiver 145 and the second transceiver 164 (shown with arrows). The third transceiver configured to send information from the user device and receive information from the first transceiver 145 and the second transceiver 164.

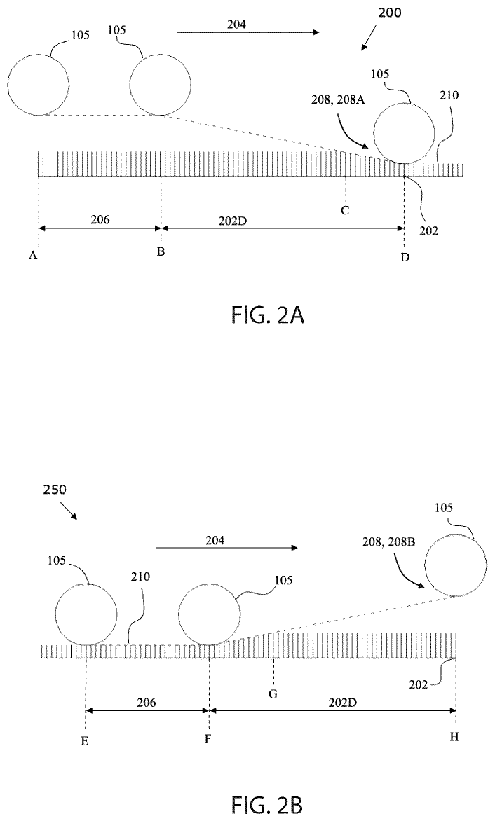

FIGS. 2A and 2B collectively illustrate depiction of actuation of an implement coupled to an autonomous work vehicle, in accordance with an embodiment of the present disclosure. FIGS. 2A and 2B are described in conjunction with elements from FIG. 1. With reference to FIGS. 2A and 2B, there is shown a velocity-based control technique for operating the implement 105 coupled to the autonomous work vehicle 110. Specifically, FIGS. 2A and 2B, illustrate an engagement sequence and a disengagement sequence for the implement 105 relative to a work surface 210.

When processor-executable instructions are executed by the processor, the processor cause the processing unit 150 to receive the sensor data 135 corresponding to at least one operating parameter of the autonomous work vehicle 110 from the sensor array 130; generate a control signal 155 for the implement control system 120 to control operation of the implement 105 corresponding to a desired point 202 along a path 204 of the autonomous work vehicle 110; calculate an offset distance 206 for execution of the control signal 155 based on at least one: of a current velocity, a maximum anticipated velocity of the autonomous work vehicle 110, and a time required to actuate the implement 105 into a desired state 208; associate the offset distance 206 with the control signal 155 as a distance 202D from the desired point 202 along the path 204 at which the control signal 155 is to be executed; and transmit the control signal 155 including the associated offset distance 206 to the vehicle control unit 140. The vehicle control unit 140 executes the control signal 155 using the offset distance 206 such that movement of the implement 105 is initiated prior to the autonomous work vehicle 110 reaching the desired point 202 and the implement 105 reaches the desired state 208 at the desired point 202 along the path 204.

The system 100 enables consistent and repeatable transition of the implement 105 into the desired state 208 at the desired point 202 along the path 204 of the autonomous work vehicle 110 without requiring manual tuning for varying operating conditions. The system 100 establishes a control structure in which execution of the control signal 155 for the implement control system 120 is coordinated using velocity information of the autonomous work vehicle 110 and the time required to actuate the implement 105 into the desired state 208 as compared to the conventional system including a distance-based implement control. Hence, the implement 105 reaches the desired state 208 at the desired point 202 regardless of changes in vehicle speed, swath angle, or geometry of the path 204. Further, the system 100 enables predictable actuation timing of the implement 105 across multiple planned actions along the path without repeated recalibration.

The system 100 further improves operational performance by reducing undesirable outcomes such as premature engagement, delayed disengagement, excessive interaction of the implement 105 with the work surface 210, or incomplete coverage of a work area. Coordinating movement of the implement 105 using the offset distance 206 results in smoother and more predictable transitions of the implement 105 between operational states, thereby reducing mechanical stress on the at least one actuator 122.

Specifically, the vehicle control unit 140 is configured to receive the sensor data 135 representative of the at least one operating parameter of the autonomous work vehicle 110 and to receive the control signal 155 associated with an operation of the implement 105. The vehicle control unit 140 may further be configured to execute the control signal 155 by issuing corresponding commands to the implement control system 120 at a determined time or location along the path 204 of the autonomous work vehicle 110.

The vehicle control unit 140 may be communicatively coupled with the steering control system 170, the speed control system 180, and the implement control system 120. The vehicle control unit 140, for example, may be integrated into a single controller or may include a plurality of distinct components or controllers. The vehicle control unit 140 may also be coupled with the sensor array 130 and receive the sensor data 135 from the sensor array 130.

The vehicle control unit 140, for example, may be used to control various aspects of the autonomous work vehicle 110 such as, for example, sending instructions to the steering control system 170, implement control system 120, speed control system 180, etc. The vehicle control unit 140, for example, may include a vehicle artificial intelligence (VAI) that may include one or more processors that execute one or more algorithms. Further, the vehicle control unit 140, for example, may receive the sensor data 135 relative to the at least one operating parameter described above.

For example, the first transceiver 145 positioned on the autonomous work vehicle 110 may output signals indicative of vehicle characteristics (e.g., position, speed, heading, curvature rate, curvature rate limits, maximum turning rate, minimum turning radius, steering angle, roll, pitch, rotational rates, acceleration, etc.) to the second transceiver 164 at the base station 160. The processing unit 150, for example, may calculate drivable path plans and/or output the control signal 155 to control the curvature rate control system 172, the speed control system 180, and/or the implement control system 120 to direct the autonomous work vehicle 110 toward the desired path, for example. Likewise, the base station 160 may include the operator interface 162, which may have similar features and/or capabilities as the operator interface 188 and the display discussed previously.

Throughout the present disclosure, the term “path” refers to a planned or executed trajectory of the autonomous work vehicle 110 along which the autonomous work vehicle 110 travels during operation. The path 204 may correspond to a linear or curved route, or a work segment defined for performing a task. In an embodiment, the path 204 may correspond to a swath along which the implement 105. The path 204 may include one or more segments having different orientations, curvatures, or lengths, and may be defined prior to vehicle operation or dynamically adjusted during operation of the autonomous work vehicle 110. In the autonomous work vehicles 110, such as mowing or ground-engaging vehicles, tasks are commonly executed along swaths.

The path 204 establishes a spatial reference for coordinating motion of the autonomous work vehicle 110 with operation of the implement 105. The path 204 is defined or represented using planned route data, trajectory segments, or control objectives stored in memory or generated by a planning module. The processing unit 150 and the vehicle control unit 140 references the path 204 to determine the desired point 202 along the path 204 at which the implement 105 is intended to reach the desired state 208.

Throughout the present disclosure, the term “desired point” refers to a target location along the path 204 at which the implement 105 is intended to reach a specified operational state. The desired point 202 may correspond to a beginning, an end, or any intermediate location of a planned action along the path 204, such as an engagement or disengagement location relative to the work surface 210. The desired point 202 is defined with respect to the path 204 of travel of the autonomous work vehicle 110 and is used as a reference for timing execution of the control signal 155 so that actuation of the implement 105 is completed at the intended location despite variations in vehicle velocity or operating conditions of the autonomous work vehicle 110.

Throughout the present disclosure, the term “control signal” refers generally to a data representation generated by the processing unit 150 and provided to the vehicle control unit 140 to execute operation of the implement 105 by the implement control system 120. The control signal 155 corresponds to the desired point 202 along the path 204 of the autonomous work vehicle 110 and includes the offset distance 206 that defines when the control signal 155 is to be executed relative to the desired point 202. The control signal 155 may encode one or more parameters defining a desired operational change of the implement 105. In other words, the control signal 155 serves as the actionable instruction that links vehicle motion information with actuation timing of the implement 105.

The control signal 155 enables synchronization of actuation of the implement 105 with motion of the autonomous work vehicle 110. By incorporating the offset distance 206 information derived from the vehicle velocity and the time required to actuate the implement 105 into the desired state 208. The control signal 155 ensures the movement of the implement 105 is initiated at an appropriate location along the path 204 such that the implement 105 reaches the desired state 208 at the desired point 202. As a result, accuracy of engagement and disengagement of the implement 105 is improved, errors caused by speed or variations in the path 204 are reduced, and undesirable outcomes such as delayed actuation, premature engagement, scalping, or missed work areas are minimized.

Throughout the present disclosure, the term “current velocity” refers to a measured or estimated speed and direction of motion of the autonomous work vehicle 110 at a given point in time. The current velocity is determined using the sensor data 135 generated by the sensor array 130 and represents the at least one operating parameter at an instant relevant to motion control and actuation timing of the implement 105. Use of the current velocity enables the system 100 to adapt actuation timing of the implement 105 to real-time vehicle motion, thereby making the current velocity a critical input for calculating the offset distance 206.

Throughout the present disclosure, the term “maximum anticipated velocity” refers to a predicted or expected upper limit of vehicle speed that the autonomous work vehicle 110 may reach while traversing a portion of the path 204. It should be noted that the processing unit 150 uses maximum anticipated velocity, either alone or in combination with the current velocity, when calculating the offset distance 206.

The maximum anticipated velocity is included to account for future changes in vehicle speed that may occur after the control signal 155 is generated but before the desired point 202 is reached. Incorporating the maximum anticipated velocity helps in calculating the offset distance 206 to remain valid even when vehicle acceleration of the autonomous work vehicle 110 occurs. The maximum anticipated velocity may be determined based on planned vehicle motion, control constraints, or historical operating data stored in memory.

Throughout the present disclosure, the term “desired state” refers to a target operational condition of the implement 105 to be achieved at the desired point 202 along the path 204. In some embodiments, the desired state 208 corresponds to a transition of the implement 105 between an engaged state 208A and a disengaged state 208B relative to the work surface 210. In this regard, the engaged state 208A corresponds to a condition in which the implement 105 is actively interacting with the work surface 210 to perform a task, and the disengaged state 208B corresponds to a condition in which the implement 105 is lifted, retracted, or otherwise positioned to avoid interaction with the work surface 210. The desired state 208 therefore represents a specific operational condition of the implement 105 to be achieved at the desired point 202 along the path 204 of the autonomous work vehicle 110.

Defining the desired state 208 as a transition between the engaged state 208A and the disengaged state 208B relative to the work surface 210 enables precise synchronization between vehicle motion and operation of the implement 105. As a result, defining the desired state 208 improves accuracy of task execution, such as initiating cutting, digging, or material handling at a specific location and terminating the operation at another. Defining the desired state 208 further reduces instances of incomplete engagement or delayed disengagement of the implement 105, and minimizes undesirable effects such as scalping, missed work areas, or unintended interaction with the work surface 210.

Throughout the present disclosure, the term “offset distance” refers to a distance along the path 204 of the autonomous work vehicle 110 measured relative to the desired point 202 at which execution of the control signal 155 is initiated. The offset distance 206 represents a spatial distance that compensates for the time required to actuate the implement 105 into the desired state 208. Use of the offset distance 206 enables improving timing accuracy of the implement 105, reducing dependency on manual tuning, and improving consistency of engagement and disengagement of the implement 105 across varying operating conditions of the autonomous work vehicle 110.

In an embodiment, the offset distance 206 is determined based on at least one of a braking capability, an acceleration capability, or a curvature limit of the autonomous work vehicle 110. In this regard, the braking capability represents a deceleration characteristic of the autonomous work vehicle 110, the acceleration capability represents a rate at which vehicle speed of the autonomous work vehicle 110 may increase, and the curvature limit represents a constraint on turning geometry or steering capability of the autonomous work vehicle 110 during path 204 traversal. Such parameters are evaluated in combination with the current velocity or the maximum anticipated velocity to adjust the offset distance such that execution of the control signal 155 compensates for vehicle motion constraints. In some embodiments, the braking capability, acceleration capability, or curvature limit, which may be obtained from stored vehicle specifications, the sensor data 135, or planning information related to the path 204.

Incorporation of the braking capability, acceleration capability, or curvature limit helps in synchronized actuation of the implement 105. Incorporation of the braking capability, acceleration capability, or curvature limit further helps in preventing deviation of the autonomous work vehicle 110 from the intended path 204 while approaching sharp turns, slowing near boundaries, or accelerating along straight segments traverses curved portions of the path 204.

In some embodiments, the processing unit 150 dynamically updates the offset distance 206 in response to changes in the sensor data 135 indicating a change in a vehicle velocity of the autonomous work vehicle 110. In this regard, the term “dynamically update” refers to recalculating or adjusting the offset distance 206 during operation of the autonomous work vehicle 110. Dynamically updating the offset distance 206 helps in appropriate actuation timing of the implement 105 under changing operating conditions of the autonomous work vehicle 110. The vehicle velocity of the autonomous work vehicle 110 may vary due to acceleration, deceleration, terrain changes, control commands, or external disturbances.

When the sensor data 135 indicates the change in the vehicle velocity, the processing unit 150 recalculates the offset distance 206 using the updated velocity information of the autonomous work vehicle 110 and the time required to actuate the implement 110 into the desired state 208. The offset distance 206, after being updated, is associated with the control signal 155 and transmitted to the vehicle control unit 140. The vehicle control unit 140 executes the control signal 155 using the offset distance 206 that has been updated as the autonomous work vehicle 110 continues along the path 204.

Dynamically updating the offset distance 206 allows the system 100 to maintain synchronization between vehicle motion and actuation of the implement 105, thereby addressing timing errors that would otherwise arise from velocity changes. Further, dynamically updating the offset distance 206 enables consistency of engagement and disengagement of the implement 105, and minimizes undesirable outcomes such as late or early actuation of the implement 105.

In some embodiments, the time required to actuate the implement 105 into the desired state includes a response latency of the at least one actuator 122 associated with the implement control system 120. In this regard, the term “response latency” refers a delay between issuance of the control signal 155 and physical movement or completion of movement of the implement 105 by the at least one actuator 122 associated with the implement control system 120. The response latency forms a component of the total actuation time required for the implement 105 to transition into the desired state 208.

The response latency may be obtained from stored characteristics of the at least one actuator 122, calibration data, sensor feedback, or empirical measurements. The processing unit 150 uses the actuation time, including the response latency, when calculating the offset distance 206. The offset distance 206, after being calculated, is transmitted to the vehicle control unit 140, which executes the control signal 155 such that movement of the implement 105 is initiated sufficiently early to compensate for the response latency of the at least one actuator 122.

In real-world scenarios, the actuation of the implement 105 may not be instantaneous. In other words, the actuation of the implement 105 may exhibit a response latency. By explicitly accounting for the response latency in determining an actuation time, the system 100 reduces timing error in actuating the implement 105, thereby improving synchronization between vehicle motion and actuation of the implement 105.

For example, FIG. 2A illustrates an arrangement 200 in which the offset distance 206 is used to initiate actuation of the implement 105 before the autonomous work vehicle 110 reaches the desired point 202 along the path 204, such that the implement 105 attains the engaged state 208A substantially at the desired point 202.

The autonomous work vehicle 110 is shown at successive positions along the path 204, with discrete locations identified as points A, B, C, and D. At point A, the processing unit 150 generates the control signal 155 corresponding to the point D along the path 204 at which the implement 105 is required to reach the engaged state 208A relative to the work surface 210. Based on the sensor data 135 generated by the sensor array 130, including vehicle velocity of the autonomous work vehicle 110, the processing unit 150 calculates the offset distance 206 corresponding to a distance 202D upstream from the point D.

At the point B, which is separated from the point A by the offset distance 206, the vehicle control unit 140 executes the control signal 155, causing the implement control system 120 to initiate movement of the implement 105. Between the point B and the point C, the implement 105 transitions from the disengaged state 208B toward the engaged state 208A while the autonomous work vehicle 110 continues traveling along the path 204. At point D, the implement 105 reaches the engaged state 208A at the desired point 202 along the path 204, thereby achieving accurate timing of engagement of the implement 105.

For example, FIG. 2B illustrates an arrangement 250 in which movement of the implement 105 is initiated prior to the desired point 202, such that the implement 105 reaches the disengaged state 208B substantially at the desired point 202.

The autonomous work vehicle 110 is shown at positions identified as points E, F, G, and H along the path 204. At point E, the implement 105 is engaged with the work surface 210. At point F, the processing unit 150 generates the control signal 155 corresponding to the disengagement point H along the path 204. The processing unit 150 calculates the offset distance 206 based on vehicle velocity and the time required to actuate the implement 105.

At point F, which is located upstream from the desired point H by the distance 202D, the vehicle control unit 140 executes the control signal 155 to initiate movement of the implement 105 toward the disengaged state 208B. Between point G and point H, the implement 105 transitions out of engagement with the work surface 210. At point H, the implement 105 reaches the disengaged state 208B at the desired point 202 along the path 204.

In each arrangement illustrated in FIGS. 2A and 2B, the offset distance 206 is determined based on the maximum anticipated vehicle velocity (Vₘₐₓ), the actuation time (T_{actuation}), of the implement 105 and the response latency. The offset distance 206 may be expressed as:

Offset distance=Vₘₐₓ×T_{actuation}+response latency.

The offset distance 206 is associated with the control signal 155 that is transmitted to the vehicle control unit 140. The offset distance 206 specifies a distance along the path 204 at which the vehicle control unit 140 should initiate the lift or lower operation of the implement 105 to ensure that the implement 105 reaches the engaged state 208A or disengaged state 208B precisely at the desired point 202.

Upon receiving the control signal 155, the vehicle control unit 140 continuously monitors the current velocity (V_{current}) of the autonomous work vehicle 110 and dynamically computes the distance remaining to the desired point 202 based on real-time vehicle motion of the autonomous work vehicle 110. Using the lift/lower reel parameters stored in the vehicle control unit 140, the vehicle control unit 140 determines when to initiate actuation of the implement 105 such that the implement 105 reaches the engaged state 208A or the disengaged state 208B at the desired point 202 along the path 204.

For example, an autonomous mower (i.e., the autonomous work vehicle 110) traveling at 2.5 meters per second approaches the point D along the path 204 where mowing should begin. The at least one actuator 122 of the implement 105 requires 0.6 seconds to fully engage, and the maximum anticipated velocity is 3.0 m/s. Using the calculation:

3.0 m/s×0.6 s=1.8 meters.

The processing unit 150 determines the offset distance 206 of 1.8 meters. Accordingly, at a location 1.8 meters upstream of the point A, the processing unit 150 generates the control signal 155, which is executed by the vehicle control unit 140 to initiate lowering of the implement 105. As the autonomous work vehicle 110 continues along the path 204, the implement 105 reaches the engaged state 208A precisely at the point D.

In another embodiment, the autonomous work vehicle 110 decelerates from 4 m/s to 2 m/s in preparation for a turn along the path 204. The implement 105 requires 0.8 seconds to reach the disengaged state 208B. The processing unit 150 and the vehicle control unit 140 continuously monitor the current velocity and dynamically recalculate the offset distance 206. For instance, the initial offset distance of 3.2 meters, based on the previous velocity, is recalculated to 1.6 meters as the autonomous work vehicle 110 slows. The vehicle control unit 140 dynamically adjusts the trigger point of the control signal 155 to initiate the lift or lower action of the implement 105 in real time. Consequently, the implement 105 reaches the disengaged state 208B at the desired point along the path 204, ensuring precise timing despite changes in vehicle velocity, acceleration, or path curvature.

Accordingly, by calculating the offset distance 206 based on maximum velocity, actuation time, response latency, and real-time vehicle velocity, the system 100 ensures that the implement 105 engages or disengages at the desired point 202 along the path 204. Dynamic recalculation by the vehicle control unit 140 further ensures consistent control of the implement 105 under varying operational conditions, thereby improving operational accuracy and efficiency of the autonomous work vehicle 110.

In some embodiments, the offset distance 206 is further adjusted to account for vehicle braking, acceleration, and curvature of the path 204. Such factors are used to compensate for variations in vehicle motion that may cause the autonomous work vehicle 110 to deviate from constant-velocity travel, thereby affecting the timing at which the implement 105 reaches the engaged state 208A or the disengaged state 208B.

The vehicle control unit 140 determines acceleration or deceleration of the autonomous work vehicle 110 based on real-time sensor data and adjusts the offset distance 206 by estimating the distance traveled during the actuation time under changing velocity conditions. When braking is detected, the offset distance 206 is reduced, and when acceleration is detected, the offset distance 206 is increased, such that actuation of the implement 105 is initiated at an appropriate upstream location.

In addition, a curvature of the path 204 is identified using planned path data or steering information. For curved path segments, the offset distance 206 is adjusted to account for reduced vehicle speed or altered vehicle dynamics while traversing the curve. The vehicle control unit 140 continuously updates the offset distance 206 using current velocity, acceleration or deceleration, and path curvature, and initiates the lift or lower action when the remaining distance to the desired point 202 corresponds to the adjusted offset distance 206.

By incorporating braking, acceleration, and curvature factors into the calculation of the offset distance 206, the system 100 ensures that the implement 105 reaches the engaged state 208A or the disengaged state 208B at the desired point 202 along the path 204 under varying operating conditions, thereby improving timing accuracy, surface quality, and operational efficiency of the autonomous work vehicle 110.

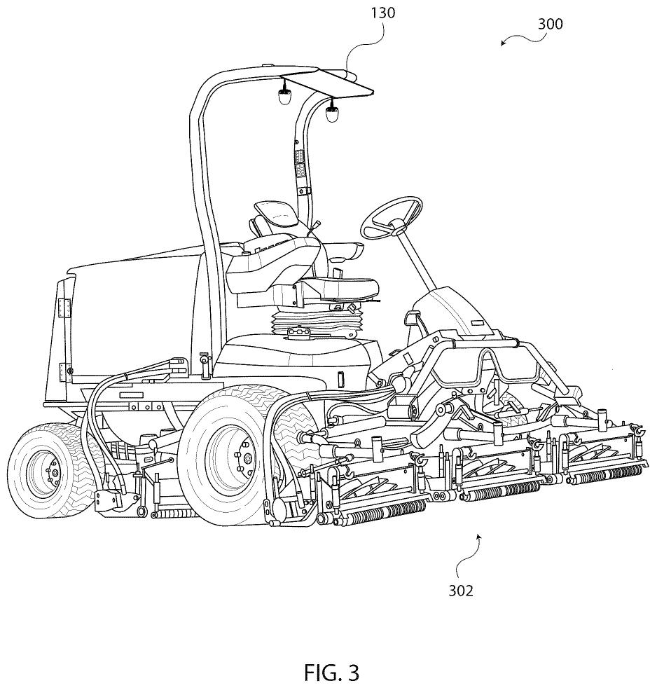

FIG. 3 is a schematic illustration of an example autonomous work vehicle, in accordance with an embodiment of the present disclosure. FIG. 3 is described in conjunction with elements from FIG. 1, FIG. 2A and FIG. 2B. With reference to FIG. 3, there is shown an autonomous mower 300, which may include all or some of the components of the autonomous work vehicle 110.

The autonomous mower 300 includes a disc mower 402. Any type of mower or blades may be used instead of the disc mower 402. The autonomous mower 300, for example, includes the sensor array 130. The sensor array 130 may include, for example, one or more lidar, radar, and/or video cameras. The video cameras, for example, may include 360-degree cameras, a front facing camera, and/or a back facing camera.

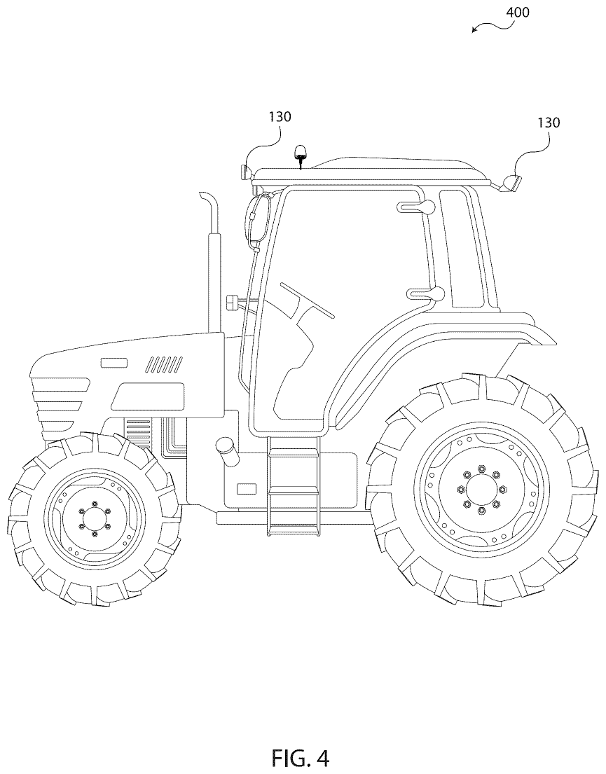

FIG. 4 is a schematic illustration of an example autonomous work vehicle, in accordance with an embodiment of the present disclosure. FIG. 4 is described in conjunction with elements from FIG. 1, FIG. 2A and FIG. 2B. With reference to FIG. 4, there is shown an autonomous tractor 400, which may include all or some of the components of the autonomous work vehicle 110.

The autonomous tractor 400 may include standard tractor equipment and/or components. The autonomous tractor 400 may include or be coupled with any kind of implement such as, for example, plow, disc plow, reel mower, dumper, lift, bucket, shovel, blade, cutter, etc. The autonomous tractor 400, for example, includes the sensor array 130. The sensor array 130 may include, for example, one or more lidar, radar, and/or video cameras. The video cameras, for example, may include 360-degree cameras, a front facing camera, and/or a back facing camera.

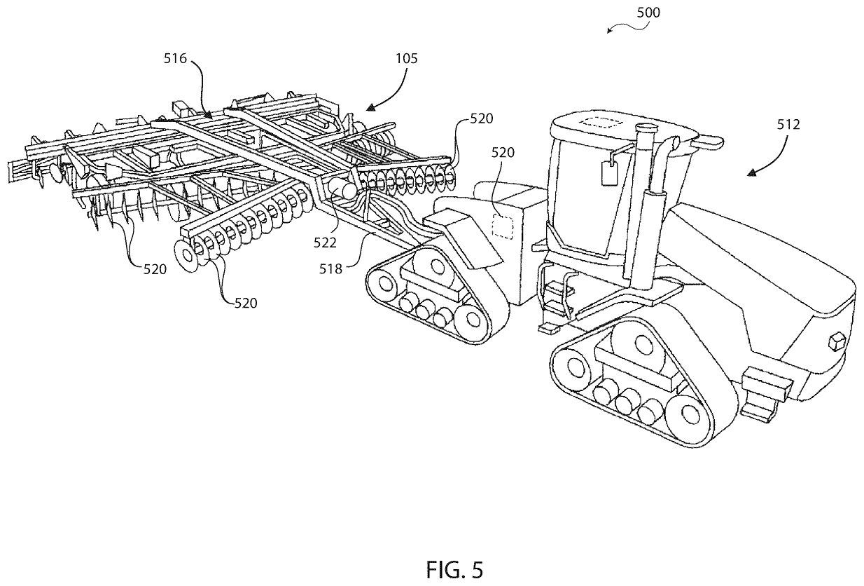

FIG. 5 is a schematic illustration of an example autonomous work vehicle, in accordance with an embodiment of the present disclosure. FIG. 5 is described in conjunction with elements from FIG. 1, FIG. 2A and FIG. 2B. With reference to FIG. 5, there is shown an autonomous tractor 400, which may include all or some of the components of the autonomous work vehicle 110 and an implement 105.

FIG. 5 is a diagram illustrating an autonomous work vehicle 500 including a tractor 512 comprising an implement 105 attached thereto. The autonomous work vehicle 500 may include a vehicle, including an autonomous work vehicle. The autonomous work vehicle may refer to the tractor 512 wherever the autonomous work vehicle is described in this document. The implement 105 in this example is a disc harrow which is pulled behind the tractor 512. In other examples, the implement may be any tillage implement including, for example, a ground engaging tool configured to penetrate a substrate, or may be a digger bucket, a dump truck bed, a plough, a harvesting implement, a cultivator, a plow, a chisel, a mower, a grader, a harvester, a rake, a rock picker, a tiller, a rotavator, a ditcher, a dozer blade, a backhoe, a seeder, a tiller, a fertilizer, a spreader, an excavator, a disc plow, a disc harrows, a blade, etc. The implement 105 may, for example, comprise a frame 516 including a tow bar 518 by which the implement 105 can be towed by the tractor 512.

In this example, a plurality of discs 520 may be arranged in rows on either side of the tow bar 518. The discs 520 may be mounted to the frame 516 with bearings (not shown) and may be configured to rotate, via the bearings, on an axis parallel to a respective row in which the disc 520 is arranged.

The autonomous work vehicle 500 may comprise a hydraulic cylinder 522 to which the implement 105 is attached and which is configured to enable movement of the implement 105 between different positions by extending and retracting. Movement of the implement 105 to a different position may relate to different positions relative to the tractor 512, or movement to a different absolute position in space. The hydraulic cylinder 522 may be a separate component to the implement 105, or in some examples, the hydraulic cylinder 522 may be considered to be a part of the implement, such that it is configured to enable movement of another part of the implement by extending or retracting. The hydraulic cylinder 522 may have its own engine or hydraulic pump, or an engine or hydraulic pump may be run be a power take-off from the tractor 512. A sensor array 560 may be disposed on the tractor 512 and may be configured to monitor the implement 105 remotely from the tractor 512, for example, with a camera, LiDAR, radar, or an infrared camera.

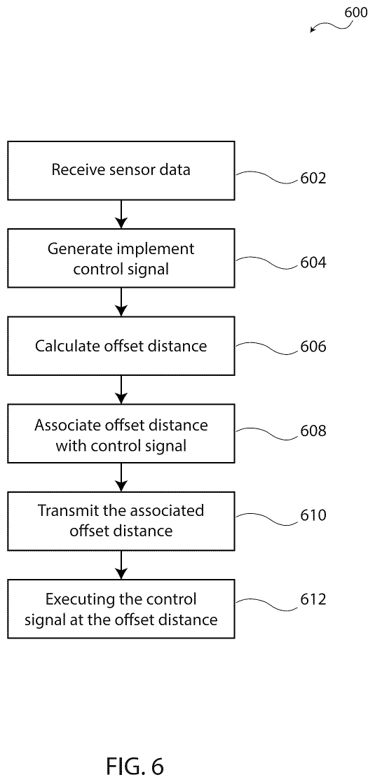

FIG. 6 is a flowchart of a process for controlling operation of the implement coupled to the autonomous work vehicle, in accordance with an embodiment of the present disclosure. With reference to FIGS. 1 to 5, there is shown a method 600 for controlling operation of the implement 105 coupled to the autonomous work vehicle 110.

At step 602, the method 600 includes receiving, by a processing unit, sensor data corresponding to at least one operating parameter of the autonomous work vehicle from a sensor array.

At step 604, the method 600 further includes generating, by the processing unit, a control signal for an implement control system to control operation of the implement corresponding to a desired point along a path of the autonomous work vehicle.

At step 606, the method 600 further includes calculating, by the processing unit, an offset distance for execution of the control signal based on at least one of: a current velocity, a maximum anticipated velocity of the autonomous work vehicle, and a time required to actuate the implement into a desired state.

In some embodiments, calculating the offset distance further includes determining the offset distance based on at least one of a braking capability, an acceleration capability, or a curvature limit of the autonomous work vehicle.

In some embodiments, calculating the offset distance further includes determining the time required to actuate the implement into the desired state based on a response latency of at least one actuator associated with the implement control system.

In some embodiments, calculating the offset distance further includes dynamically updating the offset distance in response to changes in the sensor data indicating a change in a vehicle velocity of the autonomous work vehicle.

At step 608, the method 600 further includes associating, by the processing unit, the offset distance with the control signal as a distance from the desired point along the path at which the control signal is to be executed.

At step 610, the method 600 further includes transmitting, by the processing unit, the control signal including the associated offset distance to a vehicle control unit.

At step 612, the method 600 further includes executing, by the vehicle control unit, the control signal using the offset distance such that movement of the implement is initiated prior to the autonomous work vehicle reaching the desired point and the implement reaches the desired state at the desired point along the path

The method 600 enables consistent and repeatable transition of the implement into the desired state at the desired point along the path of the autonomous work vehicle without requiring manual tuning for varying operating conditions of the autonomous work vehicle. The method 600 establishes a control approach in which execution of the control signal for the implement control system is coordinated using velocity information of the autonomous work vehicle and the time required to actuate the implement into the desired state as compared to the conventional method including a distance-based implement control. Hence, the implement reaches the desired state at the desired point regardless of changes in vehicle speed, swath angle, or geometry of the path. Further, the method enables predictable actuation timing of the implement across multiple planned actions along the path without repeated recalibration.

The method 600 further improves operational performance by reducing undesirable outcomes such as premature engagement, delayed disengagement, excessive interaction with the work surface, or incomplete coverage of a work area. Coordinating movement of the implement using offset distances results in smoother and more predictable transitions between operational states, thereby reducing mechanical stress on the implement.

In some embodiments, the method 600 further includes controlling a direction of movement of the autonomous work vehicle using a steering control system of the autonomous work vehicle and controlling at least one of speed, acceleration, or deceleration of the autonomous work vehicle using a speed control system of the autonomous work vehicle.

Controlling both direction and speed-related parameters improves accuracy and predictability of vehicle motion. Such coordinated motion control reduces deviations between expected and actual vehicle position at the time of actuation of the implement, thereby minimizing premature or delayed engagement of the implement. The method improves accuracy of the path followed by the autonomous work vehicle, supports smoother transitions in vehicle motion of the autonomous work vehicle, and reduces mechanical stress on the implement.

FIG. 7 is a block diagram of an example computational system (or controller). With reference to FIG. 7, there is shown a computational system 700.

The computational system 700 can be used to perform any of the examples disclosed in this present disclosure. For example, the computational system 700 can be used to execute a method (for example, the method 600 of FIG. 6). As another example, the computational system 700 can perform any calculation, identification and/or determination described herein. The computational system 700 includes hardware elements that can be electrically coupled via a bus 705 (or may otherwise be in communication, as appropriate). The hardware elements can include one or more processors 710, including without limitation one or more general-purpose processors and/or one or more special-purpose processors (such as digital signal processing chips, graphics acceleration chips, and/or the like); one or more input devices 715, which can include without limitation a mouse, a keyboard and/or the like; and one or more output devices 720, which can include without limitation a display device, a printer and/or the like.

The computational system 700 may further include (and/or be in communication with) one or more storage devices 725, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 700 might also include a communications subsystem 730, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 730 may permit data to be exchanged with a network (such as the network described below, to name one example), and/or any other devices described in this document. The computational system 700, for example, may include a working memory 735, which can include a RAM or ROM device, as described above.

The computational system 700 also can include software elements, shown as being currently located within the working memory 735, including an operating system 740 and/or other code, such as one or more application programs 745, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 725 described above.

The storage medium, for example, might be incorporated within the computational system 700 or in communication with the computational system 700. The storage medium might be separate from the computational system 700 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 700 and/or might take the form of source and/or installable code, which, upon compilation and/or installation on the computational system 700 (e.g., using any of a variety of generally available compilers, installation programs, compression/decompression utilities, etc.) then takes the form of executable code.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other embodiment described of the disclosure.

What is claimed is:

1. A system comprising:
an autonomous work vehicle comprising:
an implement control system configured to control operation of an implement coupled to the autonomous work vehicle;
a sensor array configured to generate sensor data representative of at least one operating parameter of the autonomous work vehicle; and
a vehicle control unit communicatively coupled to the implement control system and the sensor array; and
a processing unit communicatively coupled to the vehicle control unit, the processing unit comprising a processor and a memory storing processor-executable instructions that, when executed by the processor, cause the processing unit to:
receive the sensor data corresponding to at least one operating parameter of the autonomous work vehicle from the sensor array;
generate a control signal for the implement control system to control operation of the implement corresponding to a desired point along a path of the autonomous work vehicle;
calculate an offset distance for execution of the control signal based on at least one: of a current velocity, a maximum anticipated velocity of the autonomous work vehicle, and a time required to actuate the implement into a desired state;
associate the offset distance with the control signal as a distance from the desired point along the path at which the control signal is to be executed; and
transmit the control signal comprising the associated offset distance to the vehicle control unit;
wherein the vehicle control unit executes the control signal using the offset distance such that movement of the implement is initiated prior to the autonomous work vehicle reaching the desired point and the implement reaches the desired state at the desired point along the path.

2. The system according to claim 1, wherein the processing unit is located within a base station, the base station being remote to the autonomous work vehicle and communicatively coupled to the vehicle control unit.

3. The system according to claim 1, wherein the offset distance is determined based on at least one of a braking capability, an acceleration capability, or a curvature limit of the autonomous work vehicle.

4. The system according to claim 1, wherein the time required to actuate the implement into the desired state comprises a response latency of at least one actuator associated with the implement control system.

5. The system according to claim 1, wherein the desired state corresponds to a transition of the implement between an engaged state and a disengaged state relative to a work surface.

6. The system according to claim 1, wherein the processing unit dynamically updates the offset distance in response to changes in the sensor data indicating a change in a vehicle velocity of the autonomous work vehicle.

7. The system according to claim 1, wherein the sensor array comprises at least one of a velocity sensor, a steering angle sensor, an inertial measurement unit, a wheel encoder, a radar sensor, a lidar sensor, or a camera.

8. An autonomous work vehicle comprising:
an implement control system configured to control operation of an implement coupled to the autonomous work vehicle;
a sensor array configured to generate sensor data representative of at least one operating parameter of the autonomous work vehicle;
a vehicle control unit communicatively coupled to the implement control system and the sensor array; and
a processing unit communicatively coupled to the vehicle control unit, the processing unit comprising a processor and a memory storing processor-executable instructions that, when executed by the processor, cause the processing unit to:
receive the sensor data corresponding to at least one operating parameter of the autonomous work vehicle from the sensor array;
generate a control signal for the implement control system to control operation of the implement corresponding to a desired point along a path of the autonomous work vehicle;
calculate an offset distance for execution of the control signal based on at least one: of a current velocity, a maximum anticipated velocity of the autonomous work vehicle, and a time required to actuate the implement into a desired state;
associate the offset distance with the control signal as a distance from the desired point along the path at which the control signal is to be executed; and
transmit the control signal comprising the associated offset distance to the vehicle control unit;
wherein the vehicle control unit executes the control signal using the offset distance such that movement of the implement is initiated prior to the autonomous work vehicle reaching the desired point and the implement reaches the desired state at the desired point along the path.

9. The autonomous work vehicle according to claim 8, wherein the offset distance is determined based on at least one of a braking capability, an acceleration capability, or a curvature limit of the autonomous work vehicle.

10. The autonomous work vehicle according to claim 8, wherein the time required to actuate the implement into the desired state comprises a response latency of at least one actuator associated with the implement control system.

11. The autonomous work vehicle according to claim 8, wherein the desired state corresponds to a transition of the implement between an engaged state and a disengaged state relative to a work surface.

12. The autonomous work vehicle according to claim 8, wherein the processing unit dynamically updates the offset distance in response to changes in the sensor data indicating a change in a vehicle velocity of the autonomous work vehicle.

13. The autonomous work vehicle according to claim 8, wherein the sensor array comprises at least one of a velocity sensor, a steering angle sensor, an inertial measurement unit, a wheel encoder, a radar sensor, a lidar sensor, or a camera.

14. The autonomous work vehicle according to claim 8, further comprising:
a steering control system configured to control a direction of movement of the autonomous work vehicle; and
a speed control system configured to control at least one of speed, acceleration, and deceleration of the autonomous work vehicle.

15. A method for controlling an implement of an autonomous work vehicle, the method comprising:
receiving, by a processing unit, sensor data corresponding to at least one operating parameter of the autonomous work vehicle from a sensor array;
generating, by the processing unit, a control signal for an implement control system to control operation of the implement corresponding to a desired point along a path of the autonomous work vehicle;
calculating, by the processing unit, an offset distance for execution of the control signal based on at least one of: a current velocity, a maximum anticipated velocity of the autonomous work vehicle, and a time required to actuate the implement into a desired state;
associating, by the processing unit, the offset distance with the control signal as a distance from the desired point along the path at which the control signal is to be executed;
transmitting, by the processing unit, the control signal comprising the associated offset distance to a vehicle control unit; and
executing, by the vehicle control unit, the control signal using the offset distance such that movement of the implement is initiated prior to the autonomous work vehicle reaching the desired point and the implement reaches the desired state at the desired point along the path.

16. The method according to claim 15, wherein calculating the offset distance further comprises determining the offset distance based on at least one of a braking capability, an acceleration capability, or a curvature limit of the autonomous work vehicle.

17. The method according to claim 15, wherein calculating the offset distance comprises determining the time required to actuate the implement into the desired state based on a response latency of at least one actuator associated with the implement control system.

18. The method according to claim 15, wherein the desired state corresponds to a transition of the implement between an engaged state and a disengaged state relative to a work surface.

19. The method according to claim 15, wherein calculating the offset distance further comprises dynamically updating the offset distance in response to changes in the sensor data indicating a change in a vehicle velocity of the autonomous work vehicle.

20. The method according to claim 15, further comprising controlling a direction of movement of the autonomous work vehicle using a steering control system of the autonomous work vehicle and controlling at least one of speed, acceleration, or deceleration of the autonomous work vehicle using a speed control system of the autonomous work vehicle.
